(19) United States
(12) Patent Application Publication
(10) Pub. No.: US 2016/0186031 A1
(43) Pub. Date: Jun. 30, 2016

(54) CARBON COMPOSITES HAVING HIGH THERMAL CONDUCTIVITY, ARTICLES THEREOF, AND METHODS OF MANUFACTURE

(71) Applicants: Lei Zhao, Houston, TX (US); Zhiyue Xu, Cypress, TX (US)

(72) Inventors: Lei Zhao, Houston, TX (US); Zhiyue Xu, Cypress, TX (US)

(73) Assignee: Baker Hughes Incorporated, Houston, TX (US)

(21) Appl. No.: 14/562,942

(22) Filed: Dec. 8, 2014

(51) Int. Cl. C09K 5/14; C04B 35/622; C04B 35/52

(52) U.S. Cl. CPC C09K 5/14; C04B 35/52; C04B 35/622

(57) ABSTRACT

A carbon composite comprises a binder and carbon microstructures having interstitial spaces among the carbon microstructures and voids within carbon microstructures; wherein the binder is disposed in the interstitial spaces among the carbon microstructures and the voids within the carbon microstructures. Alternatively, a carbon composite comprises carbon microstructures and a binder disposed in the interstitial spaces among the carbon microstructures, wherein the carbon microstructures comprise less than about 15 volume percent of voids within the carbon microstructures based on the total volume of the carbon microstructures.

### BACKGROUND

Graphite is an allotrope of carbon and has a layered, planar structure. In each layer, the carbon atoms are arranged in hexagonal arrays or networks through covalent bonds. Different carbon layers however are held together only by weak van der Waals forces.

Graphite has been used in a variety of applications including electronics, atomic energy, hot metal processing, coatings, aerospace and the like due to its excellent thermal and electrical conductivities, lightness, low friction, and high heat and corrosion resistances. For example, graphite has been proposed as an alternative thermal exchange or heat sink material to replace metals such as Al, Cu, and the like. However, graphite is brittle and has low impact resistance, which severely limits its practical applications in harsh and hostile environments. In addition, although graphite has high thermal conductivity in the direction parallel to the carbon layers, it has very low thermal conductivity along the direction perpendicular to the carbon layers. The anisotropic thermal conductivity can adversely affect the overall effectiveness of graphite's heat conducting or heat releasing properties. Thus the industry is always receptive to new graphite materials having improved mechanical strength and enhanced thermal properties. It would be a further advantage if such materials also have improved high temperature corrosion resistance.

### BRIEF DESCRIPTION

The above and other deficiencies in the prior art are overcome by, in an embodiment, a carbon composite comprising a binder and carbon microstructures having interstitial spaces among the carbon microstructures and voids within carbon microstructures; wherein the binder is disposed in the interstitial spaces among the carbon microstructures and the voids within the carbon microstructures.

In another embodiment, a carbon composite comprises carbon microstructures and a binder disposed in the interstitial spaces among the carbon microstructures, wherein the carbon microstructures comprise less than about 15 volume percent of voids within the carbon microstructures based on the total volume of the carbon microstructures.

A method of manufacturing a carbon composite comprises: depositing a binder in interstitial spaces within carbon microstructures and voids among carbon microstructures to provide a filled composition; and compressing the filled composition at a temperature of about 350° C. to about 1400° C. and a pressure of about 500 psi to about 30,000 psi to form the carbon composite.

### BRIEF DESCRIPTION OF THE DRAWINGS

The following descriptions should not be considered limiting in any way. With reference to the accompanying drawings, like elements are numbered alike:

FIG. 1 illustrates the structure of natural graphite;

FIG. 2 illustrates the microstructure of expanded graphite;

FIG. 3 illustrates the microstructure of a carbon composite according to an embodiment of the disclosure;

FIG. 4(A) shows a tubular heat sink according to an embodiment of the disclosure; FIG. 4(B) shows an enlarged cross-section view of a portion of the heat sink of FIG. 4(A); and

FIG. 5(A) shows an alternative heat sink according to another embodiment of the disclosure; and FIG. 5(B) shows an enlarged cross-section view of a portion of the heat sink of FIG. 5(A).

### DETAILED DESCRIPTION

The inventors hereof have found that carbon composites having high thermal conductivity and enhanced mechanical strength can be formed from graphite and inorganic binders. Compared with traditional graphite materials, the carbon composites have improved thermal conductivity in both the direction parallel to the carbon layers and the direction perpendicular to the carbon layers. In addition, the carbon composites have dramatically increased structural strength and toughness. In a further advantageous feature, the carbon composites keep various superior properties of the graphite such as lightness, low coefficient of thermal expansion, excellent thermal shock, high chemical and thermal resistance, lubricity, and the like.

Without wishing to be bound by theory, it is believed that the improvements in thermal conductivity and mechanical strength are provided by an inorganic binder disposed within as well as among carbon microstructures.

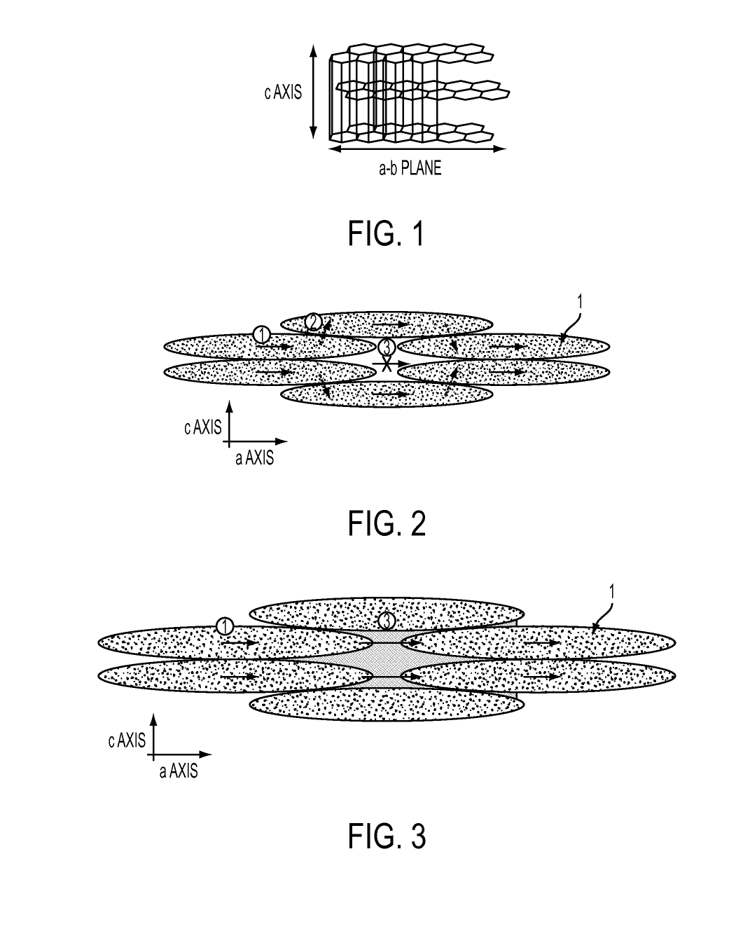

In considering the graphite structure, two axes or directions are usually noted: the “c” axis or direction and the “a” axes or directions. The “c” axis or direction may be considered as the direction perpendicular to the carbon layers (also referred to as “a-b plane”). The “a” axes or directions may be considered as the directions parallel to the carbon layers or the directions perpendicular to the “c” direction. The carbon layers of graphite can be highly aligned or oriented with respect to each other. Because of this high degree of orientation, graphite can exhibit anisotropic thermal property. The structure of natural graphite is illustrated in FIG. 1.

A microstructure of expanded graphite is illustrated in FIG. 2. Expanded graphite can comprise carbon microstructures 1, which are substantially parallel to one other. Because there are interstitial spaces among carbon microstructures, heat cannot be completely transferred along the “a” direction. As shown in FIG. 2, route 3 is not available where an interstitial void is present among the neighboring carbon microstructures. Under this circumstance, heat is conducted along routes 1 and 2. Although the thermal conductivity along route 1 is high, the thermal conductivity along route 2 is low. Thus the overall thermal conductivity of expanded graphite can be less than desirable.

A microstructure of a carbon composite according to the disclosure is illustrated in FIG. 3. As shown in FIG. 3, a conductive binder fills the interstitial spaces among the carbon microstructures. Accordingly, heat can be directly transferred along the “a” direction without any interruption, thereby improving the thermal conductivity of the graphite in the “a” direction. Meanwhile, the voids within the carbon microstructures can also be filled with a conductive binder. Thus the thermal conductivity along the “c” direction can also be improved.

The carbon composites have improved mechanical strength. There are either no forces or only weak Van der Waals forces exist between the carbon microstructures. Accordingly, the graphite bulk materials have weak mechanical strength. At high temperatures, the micro- or nano-sized binder liquefies and/or softens so that it is dispersed evenly among carbon microstructures. Upon cooling, the binder solidifies and forms a binding phase binding the carbon microstructures together through mechanical interlocking. In this manner, the mechanical properties of carbon composites can be greatly improved.

The carbon composites comprise carbon and a binder. In an embodiment, the carbon composites comprise carbon microstructures having interstitial spaces among the carbon microstructures and voids within carbon microstructures; wherein a binder is disposed in the interstitial spaces among the carbon microstructures and the voids within carbon microstructures. In another embodiment, the carbon microstructures are substantially free of voids within carbon microstructures, either filled with a binder or unfilled. In this instance, the binder is disposed in the interstitial spaces among the carbon microstructures.

The carbon can be graphite. As used herein, graphite includes one or more of natural graphite; synthetic graphite; expandable graphite; or expanded graphite. Natural graphite is graphite formed by Nature. It can be classified as “flake” graphite, “vein” graphite, and “amorphous” graphite. Synthetic graphite is a manufactured product made from carbon materials. Pyrolytic graphite is one form of the synthetic graphite. Expandable graphite refers to graphite having intercallant materials inserted between layers of natural graphite or synthetic graphite. A wide variety of chemicals have been used to intercalate graphite materials. These include acids, oxidants, halides, or the like. Exemplary intercallant materials include sulfuric acid, nitric acid, chromic acid, boric acid, SO₃, or halides such as FeCl₃, ZnCl₂, and SbCl₅. Upon heating, the intercallant is converted from a liquid or solid state to a gas phase. Gas formation generates pressure which pushes adjacent carbon layers apart resulting in expanded graphite. The expanded graphite particles are vermiform in appearance, and are therefore commonly referred to as worms.

Advantageously, the carbon composites comprise expanded graphite. Compared with other forms of the graphite, expanded graphite has high flexibility, high compression recovery, and larger anisotropy. The composites formed from expanded graphite and the binder can thus have excellent thermal conductivity in addition to desirable mechanical strength.

The carbon microstructures are microscopic structures of graphite formed after compressing graphite into highly condensed state. They comprise graphite basal planes stacked together along the compression direction. As used herein, carbon basal planes refer to substantially flat, parallel sheets or layers of carbon atoms, where each sheet or layer has a single atom thickness. The graphite basal planes are also referred to as carbon layers. The carbon microstructures are generally flat and thin. They can have different shapes and can be referred to as micro-flakes, micro-discs and the like. In an embodiment, the carbon microstructures are substantially parallel to each other.

In an embodiment, there are two types of voids in the carbon composites—voids or interstitial spaces among carbon microstructures and voids within each individual carbon microstructures. The interstitial spaces among the carbon microstructures have a size of about 0.1 to about 100 microns, specifically about 1 to about 20 microns whereas the voids within the carbon microstructures are much smaller and are generally between about 20 nanometers to about 1 micron, specifically about 200 nanometers to about 1 micron. The shape of the voids or interstitial spaces is not particularly limited. As used herein, the size of the voids or interstitial spaces refers to the largest dimension of the voids or interstitial spaces and can be determined by high resolution electron or atomic force microscope technology.

The interstitial spaces among the carbon microstructures are filled with a micro- or nano-sized binder. For example, a binder can occupy about 10% to about 90%, about 20% to about 90%, about 40% to about 90%, about 50% to about 90%, or about 60% to 90% of the interstitial spaces among the carbon microstructures. In another embodiment, to improve the thermal conductivity, the voids within the carbon microstructures are filled with the binder. For example, a binder can occupy about 10% to about 90%, about 20% to about 90%, about 40% to about 90%, or about 60% to 90% of the interstitial of the interstitial spaces within the carbon microstructures. Methods to fill the voids within the carbon microstructures include vapor deposition.

In another embodiment, the carbon microstructures are substantially free of voids within carbon microstructures, either unfilled or filled with a binder. As used herein, “substantially free of” means that the carbon microstructures contain less than about 15 vol. %, less than about 10 vol. %, less than about 5 vol. %, less than about 2 vol. % of voids within carbon microstructures based on the total volume of the carbon microstructures. For example, in the carbon composite, the carbon microstructures contain less than about 5 wt. %, less than about 2 wt. %, or less than about 1 wt. % of the binder within the carbon microstructures. It is appreciated that the binder deposited on the outer surfaces of the carbon microstructures are not considered as the binder within carbon microstructures.

The carbon microstructures have a thickness of about 1 to about 200 microns, about 1 to about 150 microns, about 1 to about 100 microns, about 1 to about 50 microns, or about 10 to about 20 microns. The diameter or largest dimension of the carbon microstructures is about 5 to about 500 microns or about 10 to about 500 microns. The aspect ratio of the carbon microstructures can be about 10 to about 500, about 20 to about 400, or about 25 to about 350. In an embodiment, the distance between the carbon layers in the carbon microstructures is about 0.3 nanometers to about 1 micron. The carbon microstructures can have a density of about 0.5 to about 3 g/cm³, or about 0.1 to about 2 g/cm³.

In the carbon composites, the carbon microstructures are held together by a binding phase. The binding phase comprises a binder which binds carbon microstructures by mechanical interlocking. Optionally, an interface layer is formed between the binder and the carbon microstructures. The interface layer can comprise chemical bonds, solid solutions, or a combination thereof. When present, the chemical bonds, solid solutions, or a combination thereof may strengthen the interlocking of the carbon microstructures. It is appreciated that the carbon microstructures may be held together by both mechanical interlocking and chemical bonding. For example the chemical bonding, solid solution, or a combination thereof may be formed between some carbon microstructures and the binder or for a particular carbon microstructure only between a portion of the carbon on the surface of the carbon microstructure and the binder. For the carbon microstructures or portions of the carbon microstructures that do not form a chemical bond, solid solution, or a combination thereof, the carbon microstructures can be bound by mechanical interlocking. The thickness of the binding phase is about 0.1 to about 100 microns or about 1 to about 20 microns. The binding phase can form a continuous or discontinuous network that binds carbon microstructures together.

Exemplary binders include a metal, an alloy, or a combination comprising at least one of the foregoing. The metal can be at least one of aluminum; copper; titanium; nickel; tungsten; chromium; iron; manganese; zirconium; hafnium; vanadium; niobium; molybdenum; tin; bismuth; antimony; lead; cadmium; or selenium. The alloy includes one or more of the following: aluminum alloys; copper alloys; titanium alloys; nickel alloys; tungsten alloys; chromium alloys; iron alloys; manganese alloys; zirconium alloys; hafnium alloys; vanadium alloys; niobium alloys; molybdenum alloys; tin alloys; bismuth alloys; antimony alloys; lead alloys; cadmium alloys; or selenium alloys. In an embodiment, the binder comprises one or more of the following: copper; nickel; chromium; iron; titanium; an alloy of copper; an alloy of nickel; an alloy of chromium; an alloy of iron; or an alloy of titanium. Exemplary alloys include steel, nickel-chromium based alloys such as Inconel*, and nickel-copper based alloys such as Monel alloys. Nickel-chromium based alloys can contain about 40-75% of Ni and about 10-35% of Cr. The nickel-chromium based alloys can also contain about 1 to about 15% of iron. Small amounts of Mo, Nb, Co, Mn, Cu, Al, Ti, Si, C, S, P, B, or a combination comprising at least one of the foregoing can also be included in the nickel-chromium based alloys. Nickel-copper based alloys are primarily composed of nickel (up to about 67%) and copper. The nickel-copper based alloys can also contain small amounts of iron, manganese, carbon, and silicon. These materials can be in different shapes, such as particles, fibers, and wires. Combinations of the materials can be used.

The binder used to make the carbon composites can be micro- or nano-sized. In an embodiment, the binder has an average particle size of about 0.05 to about 250 microns, about 0.05 to about 50 microns, about 1 micron to about 40 microns, about 0.5 to about 5 microns, or about 0.1 to about 3 microns. Without wishing to be bound by theory, it is believed that when the binder has a size within these ranges, it disperses uniformly among the carbon microstructures.

When an interface layer is present, the binding phase comprises a binder layer comprising a binder and an interface layer bonding one of the at least two carbon microstructures to the binder layer. In an embodiment, the binding phase comprises a binder layer, a first interface layer bonding one of the carbon microstructures to the binder layer, and a second interface layer bonding the other of the microstructures to the binder layer. The first interface layer and the second interface layer can have the same or different compositions.

The interface layer comprises one or more of the following: a C-metal bond; a C—O-metal bond; or a metal carbon solution. The bonds are formed from the carbon on the surface of the carbon microstructures and the binder.

In an embodiment, the interface layer comprises carbides of the binder. The carbides include one or more of the following: carbides of aluminum; carbides of titanium; carbides of nickel; carbides of tungsten; carbides of chromium; carbides of iron; carbides of manganese; carbides of zirconium; carbides of hafnium; carbides of vanadium; carbides of niobium; or carbides of molybdenum. These carbides are formed by reacting the corresponding metal or metal alloy binder with the carbon atoms of the carbon microstructures. When a combination of binder materials is used, the interface layer can comprise a combination of these carbides. The carbides can be salt-like carbides such as aluminum carbide, covalent carbides, interstitial carbides such as carbides of the group 4, 5, and 6 transition metals, or intermediate transition metal carbides, for example the carbides of Cr, Mn, Fe, Co, and Ni.

In another embodiment, the interface layer comprises a solid solution of carbon such as graphite and a binder. Carbon has solubility in certain metal matrix or at certain temperature ranges, which can facilitate both wetting and binding of a metal phase onto the carbon microstructures. Through heat-treatment, high solubility of carbon in metal can be maintained at low temperatures. These metals include one or more of Co; Fe; La; Mn; Ni; or Cu. The binder layer can also comprise a combination of solid solutions and carbides.

The carbon composites comprise about 20 to about 95 wt. %, about 20 to about 80 wt. %, or about 50 to about 80 wt. % of carbon, based on the total weight of the carbon composites. The binder is present in an amount of about 5 wt. % to about 75 wt. % or about 20 wt. % to about 50 wt. %, based on the total weight of the carbon composites. In the carbon composites, the weight ratio of carbon relative to the binder is about 1:4 to about 20:1, or about 1:4 to about 4:1, or about 1:1 to about 4:1.

The carbon composites can optionally comprise a filler. Exemplary filler includes carbon black, mica, clay, glass fiber, ceramic fibers, and ceramic hollow structures. Ceramic materials include SiC, Si₃N₄, SiO₂, BN, and the like. The filler can be present in an amount of about 0.5 to about 50 wt. %, about 0.5 to about 40 wt %, about 1 to about 40 wt. %, or about 0.5 to about 10 wt. % or about 1 to about 8%.

The carbon composites can have any desired shape including a bar, block, sheet, tubular, cylindrical billet, toroid, powder, pellets, or other form that may be machined, formed or otherwise used to form useful articles of manufacture. The sizes or the dimensions of these forms are not particularly limited. Illustratively, the sheet has a thickness of about 10 μm to about 10 cm and a width of about 10 mm to about 2 m. The powder comprises particles having an average size of about 10 μm to about 1 cm. The pellets comprise particles having an average size of about 1 cm to about 5 cm.

The carbon composites can be made by depositing a binder in the interstitial spaces among carbon microstructures and in the voids within carbon microstructures to provide a filled composition, and compressing and heating the filled composition. The carbon composite can also be prepared by blending a binder and graphite to form a filled composition; and compressing and heating the filled composition to such an extent that the formed carbon composite comprises carbon microstructures which are substantially free of voids within carbon microstructures.

A “vapor deposition” process refers to a process of depositing materials on a substrate through the vapor phase. Vapor deposition processes include physical vapor deposition, chemical vapor deposition, atomic layer deposition, laser vapor deposition, and plasma-assisted vapor deposition. Examples of the binder precursors include triethylaluminum and nickel carbonyl. Different variations of physical deposition, chemical deposition, and plasma-assisted vapor deposition can be used. Exemplary deposition processes can include plasma assisted chemical vapor deposition, sputtering, ion beam deposition, laser ablation, or thermal evaporation. Through a vapor deposition process, the binder can at least partially fill the voids within the carbon microstructures.

In an embodiment, the filled composition is first compressed to provide a green compact by cold pressing. Then the green compact is compressed and heated thereby forming the carbon composites. In another embodiment, the filled composition is pressed at room temperature to form a compact, and then the compact is heated at atmospheric pressure to form the carbon composite. Alternatively, the filled composition can be compressed and heated directly to form the carbon composites.

In the filled composition, the carbon such as graphite is present in an amount of about 20 wt. % to about 95 wt. %, about 20 wt. % to about 80 wt. %, or about 50 wt. % to about 80 wt. %, based on the total weight of the filled composition. The binder is present in an amount of about 5 wt. % to about 75 wt. % or about 20 wt. % to about 50 wt. %, based on the total weight of the filled composition. The graphite in the filled composition can be in the form of chip, powder, platelet, flake, or the like. In an embodiment, the graphite is in the form of flakes having a diameter of about 50 microns to about 5,000 microns, preferably about 100 to about 300 microns. The graphite flakes can have a thickness of about 1 to about 5 microns. The density of the filled composition is about 0.01 to about 0.05 g/cm³, about 0.01 to about 0.04 g/cm³, about 0.01 to about 0.03 g/cm³ or about 0.026 g/cm³.

As used herein, cold pressing means that the combined composition is compressed at room temperature or at an elevated temperature as long as the binder does not significantly bond with the graphite. In an embodiment, greater than about 80 wt. %, greater than about 85 wt. %, greater than about 90 wt. %, greater than about 95 wt. %, or greater than about 99 wt. % of the graphite are not bonded in the green compact. The pressure to form the green compact can be about 500 psi to about 10 ksi and the temperature can be about 20° C. to about 200° C. The reduction ratio at this stage, i.e., the volume of the green compact relative to the volume of the filled composition, is about 40% to about 80%. The density of the green compact is about 0.1 to about 5 g/cm³, about 0.5 to about 3 g/cm³, or about 0.5 to about 2 g/cm³.

The green compact can be heated at a temperature of about 350° C. to about 1400° C., specifically about 800° C. to about 1400° C. to form the carbon composites. In an embodiment, the temperature is about ±20° C. to about ±100° C. of the melting point of the binder, or about ±20° C. to about ±50° C. of the melting point of the binder. In another embodiment, the temperature is above the melting point of the binder, for example, about 20° C. to about 100° C. higher or about 20° C. to about 50° C. higher than the melting point of the binder. When the temperature is higher, the binder becomes less viscose and flows better, and less pressure may be required in order for the binder to be evenly blended with the graphite. However, if the temperature is too high, it may have detrimental effects to the instrument.

The temperature can be applied according to a predetermined temperature schedule or ramp rate. The means of heating is not particularly limited. Exemplary heating methods include direct current (DC) heating, induction heating, microwave heating, and spark plasma sintering (SPS). In an embodiment, the heating is conducted via DC heating. For example, the combined composition can be charged with a current, which flows through the composition generating heat very quickly. Optionally, the heating can also be conducted under an inert atmosphere, for example, under argon or nitrogen. In an embodiment, the green compact is heated in the presence of air.

The heating can be conducted at a pressure of about 500 psi to about 30,000 psi or about 1000 psi to about 5000 psi. For the instance where the formed carbon composite containing carbon microstructures are substantially free of intravoids, a relatively higher pressure is used, for example about 6000 psi to about 30,000 psi. The pressure can be a superatmospheric pressure or a subatmospheric pressure. In an embodiment, the desirable pressure to form the article is not applied all at once. After the green compact is loaded, a low pressure is initially applied to the composition at room temperature or at a low temperature to close the large pores in the composition. Otherwise, the melted binder may flow to the surface of the die. Once the temperature reaches the predetermined maximum temperature, the desirable pressure required to make the article can be applied. The temperature and the pressure can be held at the predetermined maximum temperature and the predetermined maximum pressure for about 5 minutes to about 120 minutes. In an embodiment, the predetermined maximum temperature is about ±20° C. to about ±100° C. of the melting point of the binder, or about ±20° C. to about ±50° C. of the melting point of the binder.

The reduction ratio at this stage, i.e. the volume of the carbon composite relative to the volume of the green compact, is about 10% to about 70% or about 20 to about 40%. The density of the carbon composite can be varied by controlling the degree of compression. The article can have a density of about 0.5 to about 10 g/cm³, about 1 to about 8 g/cm³, about 1 to about 6 g/cm³, about 2 to about 5 g/cm³, about 3 to about 5 g/cm³, or about 2 to about 4 g/cm³.

Alternatively, the filled composition can be first pressed at room temperature and a pressure of about 500 psi to 30,000 psi to form a compact; and the compact can be further heated at a temperature of about 350° C. to about 1400° C., specifically about 800° C. to about 1400° C. to make the carbon composite. In an embodiment, the temperature is about ±20° C. to about ±100° C. of the melting point of the binder, or about ±20° C. to about ±50° C. of the melting point of the binder. In another embodiment, the temperature can be about 20° C. to about 100° C. higher or about 20° C. to about 50° C. higher than the melting point of the binder. The heating can be conducted at atmospheric pressure in the presence or absence of an inert atmosphere.

In another embodiment, the carbon composite can be made from the combined composition directly without making the green compact. The pressing and the heating can be carried out simultaneously. Suitable pressures and temperatures can be the same as discussed herein in the context of heating and compressing green compact.

Hot pressing is a process that applies temperature and pressure simultaneously. It can be used the carbon composites. The carbon composites can be made in a mold. The obtained carbon composites can be further machined or shaped to form a bar, block, tubular, cylindrical billet, or toroid. Machining includes cutting, sawing, ablating, milling, facing, lathing, boring, and the like using, for example, a miller, saw, lathe, router, electric discharge machine, and the like. Alternatively, the carbon composite can be directly molded to the useful shape by choosing the molds having the desired shape.

Sheet materials such as web, paper, strip, tape, foil, mat or the like can also be made via hot rolling. In an embodiment, the carbon composite sheets made by hot rolling can be further heated to allow the binder to effectively bond the carbon microstructures together.

Carbon composite pellets can be made by extrusion. For example, a combination of the graphite and the micro- or nano-sized binder can be first loaded in a container. Then combination is pushed into an extruder through a piston. The extrusion temperature can be about 350° C. to about 1400° C. or about 800° C. to about 1400° C. In an embodiment, the temperature is about ±20° C. to about ±100° C. of the melting point of the binder, or ±20° C. to about ±50° C. of the melting point of the binder. In another embodiment, the extrusion temperature is higher than the melting point of the binder, for example, about 20 to about 50° C. higher than the melting point of the binder. In an embodiment, wires are obtained from the extrusion, which can be cut to form pellets. In another embodiment, pellets are directly obtained from the extruder. Optionally, a post treatment process can be applied to the pellets. For example, the pellets can be heated in a furnace above the melting temperature of the binder so that the binder can bond the carbon microstructures together if the carbon microstructures have not been bonded or not adequately bonded during the extrusion. Carbon composite powder can be made by milling carbon composites, for example a solid piece, through shearing forces (cutting forces).

The carbon composites have a number of advantageous properties for use in a wide variety of applications. In an especially advantageous feature, by forming carbon composites, the mechanical strength of the carbon such as graphite is greatly improved.

In addition to improved mechanical strength and high thermal conductivity, the carbon composites can also have excellent thermal stability at high temperatures. The carbon composites can have high thermal resistance with a range of operation temperatures from about −65° F. up to about 1200° F., specifically up to about 1100° F., and more specifically about 1000° F.

The carbon composites can also have excellent chemical resistance at elevated temperatures. In an embodiment, the carbon composites are chemically resistant to water, oil, brines, and acids with resistance rating from good to excellent. In an embodiment, the carbon composites can be used continuously at high temperatures and high pressures, for example, about 68° F. to about 1200° F., or about 68° F. to about 1000° F., or about 68° F. to about 750° F. under wet conditions, including basic and acidic conditions. Thus, the carbon composites resist swelling and degradation of properties when exposed to chemical agents (e.g., water, brine, hydrocarbons, acids such as HCl, solvents such as toluene, etc.), even at elevated temperatures of up to 200° F., and at elevated pressures (greater than atmospheric pressure) for prolonged periods.

The carbon composites are medium hard to extra hard with harness from about 50 in SHORE A up to about 75 in SHORE D scale.

The carbon composites are useful for preparing articles for a wide variety of applications including but are not limited to electronics, atomic energy, hot metal processing, coatings, aerospace, automotive, oil and gas, and marine applications. Thus, in an embodiment, an article comprises the carbon composites. The carbon composites may be used to form all or a portion of an article.

The carbon composites have high thermal conductivity and can be used to manufacture heat release or exchange elements. Heat release elements are typically used for rapidly releasing heat generated from electronic devices or components such as computer, CPU, and power transistor. Heat exchange elements transfer heat from one medium to another and are used in space heating, refrigeration, air conditioning power plants, chemical plants, petrochemical plants, petroleum refineries, natural gas processing, sewage treatment, and the like. Illustrative heat release or exchange elements include heat sinks, cooling systems, heating radiating components, and heat exchangers. In an embodiment the heat release element is a heat sink for laptop computers which keeps them cool while saving weight.

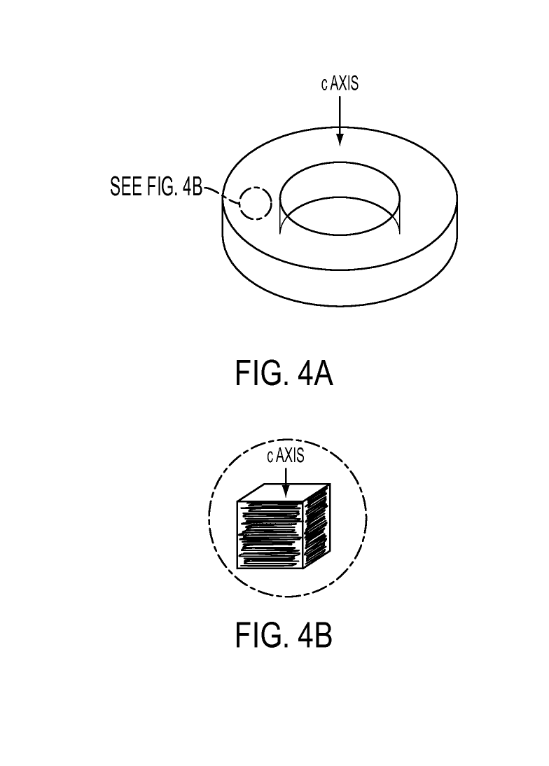

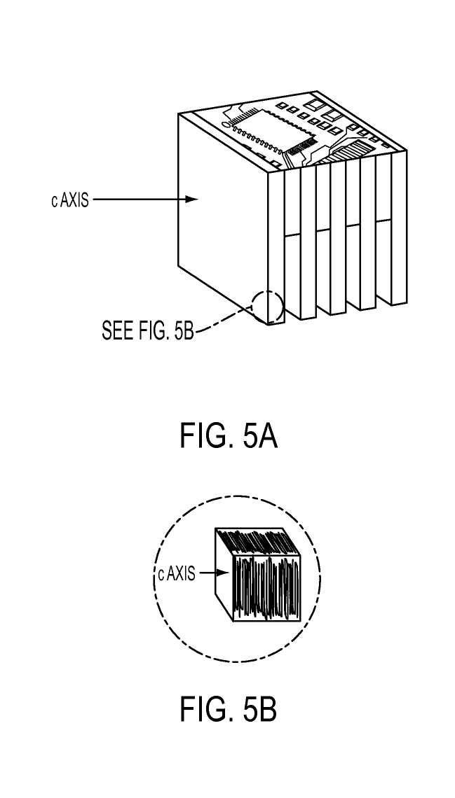

The article can be a downhole element. Illustrative articles include heat sinks for downhole motors and heat sinks for downhole electronics. Illustrative heat sink having a tubular design is shown in FIG. 4(A) and FIG.4(B). Illustrative heat sink for downhole electronics is shown in FIG. 5(A) and FIG. 5(B).

All ranges disclosed herein are inclusive of the endpoints, and the endpoints are independently combinable with each other. The suffix “(s)” as used herein is intended to include both the singular and the plural of the term that it modifies, thereby including at least one of that term (e.g., the colorant(s) includes at least one colorants). “Or” means “and/or.” “Optional” or “optionally” means that the subsequently described event or circumstance can or cannot occur, and that the description includes instances where the event occurs and instances where it does not. As used herein, “combination” is inclusive of blends, mixtures, alloys, reaction products, and the like. “A combination thereof” means “a combination comprising one or more of the listed items and optionally a like item not listed.” All references are incorporated herein by reference.

The use of the terms “a” and “an” and “the” and similar referents in the context of describing the invention (especially in the context of the following claims) are to be construed to cover both the singular and the plural, unless otherwise indicated herein or clearly contradicted by context. Further, it should further be noted that the terms “first,” “second,” and the like herein do not denote any order, quantity, or importance, but rather are used to distinguish one element from another. The modifier “about” used in connection with a quantity is inclusive of the stated value and has the meaning dictated by the context (e.g., it includes the degree of error associated with measurement of the particular quantity).

While typical embodiments have been set forth for the purpose of illustration, the foregoing descriptions should not be deemed to be a limitation on the scope herein. Accordingly, various modifications, adaptations, and alternatives can occur to one skilled in the art without departing from the spirit and scope herein.

What is claimed is:

1. A carbon composite comprising a binder and carbon microstructures having interstitial spaces among the carbon microstructures and voids within carbon microstructures; wherein the binder is disposed in the interstitial spaces among the carbon microstructures and the voids within the carbon microstructures.

2. The carbon composite of claim 1, wherein the binder comprises one or more of the following: a metal; or an alloy of the metal; and wherein the metal is one or more of the following: aluminum; copper; titanium; nickel; tungsten; chromium; iron; manganese; zirconium; hafnium; vanadium; niobium; molybdenum; tin; bismuth; antimony; lead; cadmium; or selenium.

3. A carbon composite comprising carbon microstructures and a binder disposed in interstitial spaces among the carbon microstructures, wherein the carbon microstructures comprise less than about 15 volume percent of voids within the carbon microstructures based on the total volume of the carbon microstructures.

4. The carbon composition of claim 3, wherein the carbon microstructures comprises less than about 5 wt. % of the binder within the carbon microstructures.

5. The carbon composite of claim 1, wherein the carbon microstructures comprise microstructures of one or more of the following: expanded graphite; expandable graphite; natural graphite; or synthetic graphite.

6. The carbon composite of claim 5, wherein the carbon microstructures comprise microstructures of expanded graphite.

7. The carbon composite of claim 1, wherein the interstitial spaces among the carbon microstructures have a size of about 0.1 micron to about 100 microns.

8. The carbon composite of claim 1, wherein the voids within the carbon microstructures has a size of about 20 nanometers to about 1 micron.

9. The carbon composite of claim 1, wherein the binder occupies about 50% to about 90% of the interstitial spaces among the carbon microstructures, and wherein the binder fills about 10% to about 90% of the voids within the carbon microstructures.

10. The carbon composite of claim 1, wherein the carbon composite comprises at least two carbon microstructures and a binding phase disposed between the at least two carbon microstructures; and wherein the binding phase comprises the binder.

11. The carbon composite of claim 10, wherein the binding phase comprises a binder layer and an interface layer bonding one of the at least two carbon microstructures to the binder layer; and wherein the interface layer comprises one or more of the following: a C-metal bond; a C—O-metal bond; or a metal carbon solution.

12. The carbon composite of claim 1, wherein the composite is in the form of a bar, block, sheet, tubular, cylindrical billet, toroid, powder, or pellets.

13. A sheet comprising the carbon composite of claim 1, wherein the sheet has a thickness of about 10 μm to about 10 cm.

14. An article comprising the composition of claim 1.

15. An article comprising the composition of claim 3.

16. The article of claim 14, wherein the article is a heat release or exchange element.

17. The article of claim 16, wherein the article is a heat sink; a cooling system; a heating radiating component; or a heat exchanger.

18. The article of claim 14, wherein the article is a downhole element.

19. A method of manufacturing a carbon composite, the method comprising:
depositing a binder in interstitial spaces within carbon microstructures and voids among carbon microstructures to provide a filled composition; and
compressing the filled composition at a temperature of about 350° C. to about 1400° C. and a pressure of about 500 psi to about 30,000 psi to form the carbon composite.

20. The method of claim 19, wherein the depositing comprises physical vapor deposition, chemical vapor deposition, atomic layer deposition, laser vapor deposition, or plasma-assisted vapor deposition.

21. The method of claim 19, wherein the binder has a size of about 0.05 to about 250 microns.

22. The method of claim 19, wherein the compressing is conducted in a mold to form a bar, block, sheet, tubular, cylindrical billet, or toroid comprising the carbon composite.

23. The method of claim 19, further comprising machining or shaping the carbon composite to form a bar, block, sheet, tubular, cylindrical billet, or toroid.
